(19) United States
(12) Patent Application Publication
(10) Pub. No.: US 2016/0263780 A1
(43) Pub. Date: Sep. 15, 2016

(54) VULCANIZATION SYSTEMS FOR CURING BLOCK COPOLYMER LATEX FILMS

(71) Applicant: KRATON POLYMERS U.S. LLC, Houston, TX (US)

(72) Inventor: Wouter DE JONG, ALMERE (NL)

(73) Assignee: KRATON POLYMERS U.S. LLC, HOUSTON, TX (US)

(21) Appl. No.: 15/064,806

(22) Filed: Mar. 9, 2016

Related U.S. Application Data
(60) Provisional application No. 62/130,298, filed on Mar. 9, 2015.

(51) Int. Cl. B29C 35/02; C08J 5/02; C08J 3/24; C08J 5/18

(52) U.S. Cl. CPC B29C 35/02; C08J 5/18; C08J 5/02; C08J 3/247; B29K 2007/00

(57) ABSTRACT

A method for the curing of aqueous latexes comprising block copolymers is disclosed. The block copolymers have the general formula A-B-A or A-B-Y-(B-A)ₙ. The curing is conducted using vulcanization systems that are free of guanidine and thiuram compounds. The cured latexes are useful in the manufacture of elastic films, surgical, examination and electrical insulation gloves, industrial gloves and condoms.

### FIELD OF THE INVENTION

The invention relates to methods for curing latexes comprising block copolymers using guanidine-free and thiuram-free accelerators. The invention further comprises articles including films, surgical gloves, examination gloves, electrical insulation gloves, industrial gloves, and condoms made by latex curing method.

### BACKGROUND OF THE INVENTION

Natural rubber latex has been applied for many years as a material for glove and condom manufacture. While the physical properties of cured natural rubber make it an excellent choice for such applications, natural rubber latex does present the risk of allergic reactions. Type I hypersensitivity may occur in response to the proteins present in the natural rubber latex.

It is well known that synthetic materials avoid the Type I skin sensitivity and allergy problems associated with natural rubber. One such material is synthetic polyisoprene and latexes made from them are taught in U.S. Pat. No. 8,163,838 B2. These latexes can be formed into thin film articles such as gloves and condoms. In order to be useful as such articles the thin films must be cured using a formulated package of curing accelerator chemicals such as taught in U.S. Pat. No. 6,828,387 B2. However, these vulcanization systems present the risk of producing Type IV allergic responses. The wearer of these articles may develop an allergic response after repeated exposure to the residual chemicals in the cured articles.

Another example of synthetic polymers which lack natural rubber proteins are block copolymers comprising blocks of styrene and blocks of isoprene. Latexes comprising these synthetic polymers are taught in US Pat. App. No. 2014/171,540 A1. The materials have the additional advantage that they may physically crosslink through glassy polystyrene domains. In this way, articles made from such latexes can be physically cured rather than chemically cured and will not contain the curing chemicals thought to induce Type IV allergic reactions.

In the case where the articles formed from the block copolymer latexes are physically cured without accelerator or curing agents the physical properties may be sufficient for some applications. However, it could be advantageous to develop an enhanced cure system which comprises an vulcanization system free of sensitizing agents. In this way, rubber latex articles could be formed possessing superior physical properties and yet having no or low risk of Type IV allergic reaction.

The present invention addresses this needed by providing methods to cure articles made from block copolymer latexes without the application of guanidine or thiuram compounds where such methods provide strong, elastic films.

### SUMMARY OF THE INVENTION

In the most general sense the present invention is a method to cure a latex comprising a block copolymer and a guanidine-free and thiuram-free accelerator such method comprising the steps of forming a solid film from the latex and curing the film at an elevated temperature.

In one embodiment the invention is a method comprising block copolymers comprised of mono-alkenyl arene blocks and conjugated diene blocks. Specifically, it is a method for curing a latex comprising water, a block copolymer, and a guanidine-free and thiuram-free accelerator where the method comprises the steps of forming a solid film from the latex, and curing the film by heating to a temperature from 100° C. to less than 130° C. In a second embodiment the invention is a method having an accelerator which comprises sulfur, zinc-diethyldithio-carbamate, and zinc-2-mercapto-benzo-thiazole.

In a third embodiment the invention is a method comprising block copolymers having a general formula A-B-A or A-B-Y-(B-A)ₙ where n represents the average number of arms in a coupled polymer and ranges from 1 to 6 and Y represents the residue of a coupling agent.

In a fourth embodiment the invention is a method comprising block copolymers with A block(s) having a weight average molecular weight from 9,000 to 15,000 and B block(s) having a weight average molecular weight from 75,000 to 150,000.

In a fifth embodiment the invention comprises articles such as films, balloons, surgical gloves, examination gloves, electrical insulation gloves, industrial gloves or condoms made by the inventive method.

### DETAILED DESCRIPTION OF THE INVENTION

The block copolymers of the present invention may be prepared by well-known anionic polymerization processes known in the art. These processes typically use an organolithium compound as initiator in an inert solvent.

In the method of the present invention the block copolymers comprise at least two blocks (A) of polymerized mono alkenyl arene and at least one block (B) of polymerized conjugated diene. The blocks of the copolymer may be arranged in a linear fashion or in a radial fashion. The block copolymers are so represented by the formulae A-B-A and A-B-Y-(B-A)ₙ where Y represents the residue of a coupling agent and n+1 represents the average number of arms in the radial structure. The preferred structure is the radial structure.

The A block is formed by polymerization of mono-alkenyl arene monomers. The mono-alkenyl arene may be styrene, α-methylstyrene, methylstyrenes other than α-methylstyrene, vinyl toluene, para-butylstyrene, ethylstyrene and vinylnapthalene, and these can be used alone or in combination of two or more. Preferred is styrene.

The B block is a polymer block of a conjugated diene and has rubbery character. The conjugated diene may be 1,3-butadiene, substituted butadiene such as isoprene, piperylene, 2,3-dimethyl-1,3-butadiene, myrcene, and 1-phenyl-1,3-butadiene or mixtures thereof. Preferred is isoprene.

When the block copolymer has a radial structure A-B living diblock arms are first formed by sequential, anionic polymerization and then coupled using a coupling agent having a functionality of 3 or greater. Typical coupling agents are polyepoxides, polyisocyanates, polyimines, polyaldehydes, polyketones, polyanhydrides, polyesters, polyhalides, and the like. These compounds can contain two or more types of functional groups such as the combination of epoxy and aldehyde groups, isocyanate and halide groups, and the like. Many suitable types of these polyfunctional compounds have been described in U.S. Pat. No. 3,595,941, U.S. Pat. No. 3,468,972, U.S. Pat. No. 3,135,716, U.S. Pat. No. 3,078,254 and U.S. Pat. No. 3,594,452. A preferred coupling agent is γ-glycidoxy-propyl-trimethoxy-silane (GPTS).

Under suitable conditions, these diblock S-M copolymer arms couple together thus forming a triblock copolymer when (n+1) equals 2 (meaning 2 arms of diblock are coupled together) or a radial type polymer when (n+1) is greater than 2. The coupling process is a statistical process and the resulting average value of (n+1) for the overall block copolymer composition represents the average number of arms of the radial structure in the block copolymer composition. For example a coupled block copolymer composition in which the target structure is a linear triblock (n=1) may also contain uncoupled diblock, three-armed radial structures (n=2), four-armed radial structures (n=3), etc. where the coupling conditions and efficiency of the coupling reactions will determine the distribution of structures within the resulting block copolymer composition.

Coupling efficiency is defined as the number of molecules of coupled polymer divided by the number of molecules of coupled polymer plus the number of molecules of uncoupled polymer. Coupling efficiency can be determined theoretically from the stoichiometric quantity of coupling agent required for complete coupling, or coupling efficiency can be determined by an analytical method such as gel permeation chromatography. In the present invention coupling efficiency is greater than 90%, preferably from 92% to about 100%.

In the radial block copolymer structure the A blocks preferably have average molecular weights between about 10,000 and about 12,000. The B blocks preferably have average molecular weights between about 75,000 and about 150,000, preferably between about 80,000 and about 120,000. The weight percentage of the A blocks in the finished block polymer should be between 8 and 15%, preferably between 10% and 12% by weight.

When the block copolymer is a linear polymer the A-B-A structure can be formed by linear sequential polymerization or by coupling living A-B arms. In these linear block copolymers each A block has a molecular weight of from 8,000 to 15,000, preferably from 9,000 to 14,000. The total molecular weight of the block copolymer ranges from 150,000 to 250,000, preferably from 170,000 to 220,000. The block copolymer has a monoalkenyl arene content of from 8 to 15 wt. %, preferably 9 to 14 wt. %, based on the total weight of the block copolymer.

The molecular weights referred to in this specification and claims can be measured with gel permeation chromatography (GPC) using polystyrene calibration standards, such as is done according to ASTM D5296. GPC is a well-known method wherein polymers are separated according to molecular size, the largest molecule eluting first. The chromatograph is calibrated using commercially available polystyrene molecular weight standards. The molecular weight of polymers measured using GPC so calibrated are styrene equivalent molecular weights, also referred to as apparent molecular weights. The styrene equivalent molecular weight may be converted to true molecular weight when the styrene content of the polymer and the vinyl content of the diene segments are known. The detector used is preferably a combination ultraviolet and refractive index detectors. The molecular weights expressed herein are measured at the peak of the GPC trace and are commonly referred to as “peak molecular weights”. Unless otherwise specified, the term “molecular weights” refers to the molecular weight measured at the appropriate peak of the GPC trace and subsequently converted to true molecular weight in g/mol of the polymer or block of the copolymer.

Thin walled rubber articles can be prepared from a latex having a solids content of from 20 to 80%, more preferably of from 30 to 70% by weight. Most preferably the latex has a solids content of from 35 to 65% by weight.

Antioxidants for polymer stabilization are well known. They are commonly used to inhibit polymer oxidation that occurs via chain terminating reactions. The degradation of polymers can occur during various stages of the polymer lifecycle from initial manufacture, through to fabrication and then subsequent exposure to the environment. Oxygen is the major cause of polymer degradation and its effect can be accelerated by other factors such as sunlight, heat, mechanical stress and metal ion contaminates. Polymer degradation during thermal processing and weathering occurs through an autoxidative free radical chain reaction process. This involves the generation of free radicals, then propagation reactions leading to the formation of hydroperoxides and finally termination reactions where radicals are consumed. Hydroperoxides are inherently unstable to heat, light and metal ions, readily decomposing to yield further radicals so continuing the chain reaction.

For the preparation of the latex anionic, cationic or non-ionic surfactants or combinations thereof may be used. The surfactant is present in a sufficient amount to emulsify the block copolymer. To produce the latex the block copolymer, usually in the form of a solution in an organic solvent, is dispersed in water using a suitable surfactant or a combination of surfactants and the organic solvent is removed. A suitable procedure is disclosed in, e.g., U.S. Pat. No. 3,238,173.

Vulcanization according to the present invention may be carried out using ingredients and conditions common in the vulcanization of natural and synthetic polydiene rubbers. Such combination of ingredients is referred to as the vulcanization system. Thus, sulphur and/or sulphur compounds may be used to create cross-links between the unsaturated bonds in the rubber chains of the B blocks. As is known from, for example, WO Pat. No. 2007/017368 it is also possible to use one or more other additives, generally known as accelerators. Therefore, it is preferred to use a vulcanization system in the present invention comprising sulfur or a sulfur compound and one or more accelerators. However, it is essential that the vulcanization system does not contain thiuram compounds or guanidine compounds. The vulcanization system of the present invention is guanidine-free and thiuram-free.

The vulcanization systems of the present invention necessarily lack guanidine and thiuram compounds. One such vulcanization system is commercially available from Akron Dispersions under the trade name Bostex 866. Bostex 866 is an aqueous mixture comprising primarily of zinc diethyldithiocarbamate, zinc 2-mercapto-benzothiazole, zinc oxide, and sulfur. To prepare a thin walled rubber article from the latex, such as a film, a suitable surface is coated with the latex and the water thereafter removed by evaporation. A second or further layer may be provided in the same manner to achieve thicker films. The film resulting from the foregoing procedure is dried and annealed with preferred temperatures for drying and annealing varying from 25 to 130° C.

To prepare a dipped article, a similar process is used, wherein a mold is dipped into the latex. In a preferred embodiment of the process for making a thin walled article, the mold is dipped into the latex. The dip-coated mold is then removed from the latex and dried. The mold may be dip coated more than once in the same latex. In an alternative process a mold is dip-coated in a first latex, followed by (air) drying and dip-coating in a second latex and so forth. In this way balloons, and condoms may be made. In a different embodiment, the mold may be dipped in a dispersion of a coagulant, the coagulant on the surface of the mold may be dried, and subsequently, the mold is dipped into the rubber latex. The latter manner is especially used for the manufacture of gloves.

For the purposes of this invention the term film refers to all such forms described above whether made by coating and evaporation or by any variety of dipping.

In the preferred method of the invention a film is formed and then cured by heating the film to a temperature from 100° C. to less than 130° C. More preferably the film is heated from 110° C. to 125° C.

In this way articles such as films, balloons, surgical gloves, examination gloves, electrical insulation gloves, industrial gloves or condoms are made by the inventive method.

### EXAMPLES

Latexes illustrative of the invention were made using Polymer 1 and Comparative Polymer 1. Polymer 1 was a radial block copolymer with A blocks composed of polymerized styrene monomer and B blocks comprised of polymerized isoprene monomer. The MW of the A blocks were 11,800, the MW of the B blocks were 96,000, the coupling agent was γ-glycidoxy-propyl-trimethoxy-silane (GPTS), and the average number of arms (n) was 2.7. Comparative Polymer 1 was a linear, high molecular weight, anionically synthesized polyisoprene having a molecular weight of 2,800,000.

The latexes were diluted to 30-35% solids and 0.75 phr Manawet 172 surfactant was added. The diluted latices were subsequently compounded with the various vulcanization packages and pH was increased to 11 by the addition of a 10% KOH solution.

To obtain thin-walled dipped goods metal plates (15×9 cm) were used. The formers were heated in an oven at 100° C. and then dipped for 30 seconds in a coagulant solution. The formers were dried in the same 100° C. oven for at least 90 seconds and then dipped into the compounded latex dispersion for (20 to 30 seconds). Immediately after dipping, the samples were pre-vulcanized at 130° C. for 48 seconds, followed by a leaching step in a water bath at 50° C. for 5 minutes. The films were vulcanized at 120° C. (Polymer 1) or 130° C. (Comparative Polymer 1) for 20 minutes. The films were dusted with silica powder and removed from the formers. Samples were kept at 20° C. overnight and their mechanical properties were measured one day after dipping.

Films were dipped from the compounds for a week.

Mechanical properties of the dipped films were measured according to ASTM D412/ISO37 using die C.

The swell of the material was measured by cutting a circular piece of the film with a diameter of 15 mm. This was placed in toluene in a petri-disc and after 1 hour the diameter of the swollen film was measured.

### Example 1

The latex containing Polymer 1 was compounded with Bostex 866 at two concentrations, 2.5 and 5 phr. Mechanical properties of the films dipped from the two compounds are collected in Table 1.

TABLE 1

| | 2.5 phr | | | 5 phr | | |
|---|---|---|---|---|---|---|
| | Day 1 | Day 4 | Day 7 | Day 1 | Day 4 | Day 7 |
| Tensile strength (MPa) | 27 | 25 | 27 | 25 | 26 | 28 |
| Young's modulus MPa) | 0.19 | 0.22 | 0.21 | 0.26 | 0.23 | 0.23 |
| 500% modulus (MPa) | 1.85 | 1.68 | 1.78 | 2.12 | 2.07 | 2.08 |
| Elongation (%) | 1052 | 1051 | 1062 | 1030 | 1031 | 1059 |
| Toluene swell (mm) | 39 | 38 | 39 | 36 | 36 | 36 |

High tensile strength was measured on films dipped from both Bostex 866 compounds starting at day 1. Toluene swell could also be measured from the start which is an indication that cross-linking has indeed occurred (non-cross-linked films from Polymer 1 will dissolve in toluene).

The degree of swell in toluene indicated that mild vulcanization occurred.

### Example2 (Comparative)

Latexes prepared from Comparative Polymer 1 were compounded with Bostex 866 at 3 concentrations. The dipped films were cured at 130° C. for 20 minutes. Results of curing latexes of Comparative Polymer 1 are shown in Table 2. Even though films made from the latexes of Comparative Polymer 1 were cured at a higher temperature than those of Polymer 1, they had inferior properties. This is clearly shown by comparison of results at 5 phr.

TABLE 2

| | 5 phr | | | 7 phr | | | 9 phr | | |
|---|---|---|---|---|---|---|---|---|---|
| | Day 1 | Day 4 | Day 7 | Day 1 | Day 4 | Day 7 | Day 1 | Day 4 | Day 7 |
| Tensile strength (MPa) | 8 | 12 | 13 | 9 | 12 | 13 | 13 | 18 | 14 |
| Young's modulus MPa) | 0.14 | 0.18 | 0.14 | 0.15 | 0.13 | 0.14 | 0.18 | 0.18 | 0.15 |
| 500% modulus (MPa) | 0.81 | 0.99 | 1.04 | 1.04 | 1.03 | 1.07 | 1.33 | 1.69 | 1.68 |
| Elongation (%) | 1636 | 1143 | 1127 | 991 | 1089 | 1052 | 976 | 982 | 889 |
| Toluene swell (mm) | 35 | 29 | 29 | 29 | 30 | 30 | 28 | — | — |

Thus it is apparent that there has been provided, in accordance with the invention, a block copolymer latex and articles formed from such latex that fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly it is intended to embrace all such alternatives, modifications and variations as fall within the spirit and broad scope of the appended claims.

1. A method for curing a latex comprising water, a block copolymer, and a guanidine-free and thiuram-free vulcanization system such method comprising:
a. forming a solid film from the latex,
b. curing the film by heating to a temperature from 100° C. to less than 130° C.

2. The method of claim 1, where in the block copolymer comprises at least one mono-alkenyl arene block (A) and at least one conjugated diene block (B).

3. The method of claim 2, wherein the mono-alkenyl arene is styrene.

4. The method of claim 2, wherein the mono-alkenyl arene constitutes 8 to 15 wt. % of the total block copolymer.

5. The method of claim 2, wherein the conjugated diene is isoprene, butadiene, or mixtures thereof.

6. The method of claim 5, wherein the conjugated diene is isoprene.

7. The method of claim 2, wherein the block copolymer has the general formula
A-B-A or A-B-Y-(B-A)n where (n+1)
represents the average number of arms in a coupled polymer and n ranges from 1 to 6 and Y represents the residue of a coupling agent.

8. The method of claim 2, wherein the molecular weight of the A block is from 9,000 to 15,000.

9. The method of claim 2, wherein the molecular weight of the B block is from 75,000 to 150,000.

10. The method of claim 7, wherein the coupling efficiency is at least 90%.

11. The method of claim 7, wherein the coupling agent is γ-glycidoxy-propyl-trimethoxy-silane.

12. The method of claim 1, wherein the vulcanization system comprises sulfur, zinc-diethyldithio-carbamate, and zinc-2-mercapto-benzo-thiazole.

13. The method of claim 1, wherein the curing temperature is from 110 to 125° C.

14. The method of claim 1, further comprising the step of increasing the pH of the latex to 10 or greater by addition of an aqueous base before curing the film.

15. The method of claim 1, wherein the latex comprises from 20 to 80 wt. % of the block copolymer.

16. An article prepared by the method of claim 1.

17. The article of claim 16, which is a thin walled article or a dipped article.

18. The article of claim 16, which is a film, balloon, surgical glove, examination glove, electrical insulation glove, industrial glove or condom.
